(19) United States
(12) Patent Application Publication
(10) Pub. No.: US 2020/0232696 A1
(43) Pub. Date: Jul. 23, 2020

(54) Cold Storage For In-Vehicle Use

(71) Applicant: SANDEN RETAIL SYSTEMS CORPORATION, Isesaki-shi (JP)

(72) Inventors: Shigekazu KOIKE, Isesaki-shi (JP); Masaru OCHIAI, Isesaki-shi (JP); Hikaru SUDA, Isesaki-shi (JP); Masayuki SEKIGUCHI, Isesaki-shi (JP)

(21) Appl. No.: 16/483,214

(22) PCT Filed: Jan. 12, 2018
(86) PCT No.: PCT/JP2018/001477

§ 371 Date: Aug. 2, 2019

(30) Foreign Application Priority Data
Feb. 13, 2017 (JP) 2017-023947

(51) Int. Cl. F25D 11/00; F25D 17/06

(52) U.S. Cl. CPC F25D 11/006; B64D 11/04; F25D 17/06

(57) ABSTRACT

Cold air storage for in-vehicle use having a body duct 22 communicating with a back portion of a cold accumulating chamber 18 and extending to a ceiling portion of a cold storage chamber 3, an outlet 23 formed in the body duct and opening at the ceiling portion of the cold storage chamber, a fan 7 blowing cold air which has heat-exchanged with a cold accumulating agent 6 from the outlet through the body duct, a metal door duct member 24 attached to the inside of the door 8 with an interval, and a door duct 26 configured between the door duct member and the door. When the door closes a front opening portion of the cold storage chamber, an upper portion of the door duct communicates with the outlet and a lower portion of the door duct communicates with a front portion of the cold air accumulating chamber.

### TECHNICAL FIELD

The present invention relates to a cold storage for in-vehicle use conveyed with a transportation vehicle or the like and cooling various articles in a cold storage chamber.

### BACKGROUND ART

Conventionally, as this type of cold storage for in-vehicle use, one is known which is provided with a body having an opened front surface, a cooling device cooling the inside of the chamber (cold storage chamber), a chamber-inside fan (fan) circulating cold air inside the chamber, and a cold accumulating agent cooled with the cooling device and which is conveyed with a transportation vehicle while circulating the cold air cooled by the cold accumulating agent inside the chamber by the fan to cool various articles during conveyance (for example, refer to Patent Document 1).

### CITATION LIST

### Patent Document

Patent Document 1: Japanese Patent Application Laid-Open Publication No. 2002-147923

### SUMMARY OF THE INVENTION

### Problems to be Solved by the Invention

However, the conventional cold storage for in-vehicle use has been configured to blow a large amount of cold air to the inside of the chamber (cold storage chamber) and circulate the cold air by the fan. Therefore, there has been a problem that, when articles vulnerable to dryness, such as fresh vegetables, are conveyed, moisture is removed (dried) by contacting a large amount of circulated cold air, so that the quality deteriorates, for example.

The present invention has been made in order to solve the above-described conventional technical problem. It is an object of the present invention to provide a cold storage for in-vehicle use capable of preventing or suppressing the deterioration in the quality also in conveying articles vulnerable to dryness.

### Means for Solving the Problems

A cold storage for in-vehicle use of the present invention is obtained by configuring a cold storage chamber in a heat insulating body and openably/closably closing a front opening portion of the cold storage chamber with a heat insulating door and is provided with a cold accumulating chamber configured in a bottom portion in the body, a cold accumulating agent provided in the cold accumulating chamber, a metal partition plate attached to the inside of a back surface and a top surface of the body with an interval, a body duct configured between the partition plate and the body and extending to a ceiling portion of the cold storage chamber while communicating with a back portion of the cold accumulating chamber, an outlet formed in the body duct and opening at the ceiling portion of the cold storage chamber, a fan blowing cold air which has heat-exchanged with the cold accumulating agent from the outlet through the body duct, a metal door duct member attached to the inside of the door with an interval, and a door duct configured between the door duct member and the door, in which an upper portion of the door duct communicates with the outlet and a lower portion of the door duct communicates with a front portion of the cold accumulating chamber in a state where the door closes the front opening portion of the cold storage chamber.

In the cold storage for in-vehicle use of the invention of Claim 2, the upper portion of the door duct member abuts on the partition plate around the outlet through a seal material in the state where the door closes the front opening portion of the cold storage chamber in the invention described above.

In the cold storage for in-vehicle use of the invention of Claim 3, a plurality of small holes is formed in the door duct member in each invention described above.

In the cold storage for in-vehicle use of the invention of Claim 4, a larger number of small holes are formed in an upper portion than in a lower portion of the door duct member in the above-described invention.

In the cold storage for in-vehicle use of the invention of Claim 5, the inside of the cold storage chamber communicates with the front portion of the cold accumulating chamber in the invention of Claim 3 or Claim 4.

The cold storage for in-vehicle use of the invention of Claim 6 is provided with a bottom plate provided in the cold storage chamber and partitioning and forming the cold accumulating chamber below, in which the door duct member is located on the front side with respect to the front end of the bottom plate in the state where the door closes the front opening portion of the cold storage chamber in each invention described above.

In the cold storage for in-vehicle use of the invention of Claim 7, the outlet is located in a central portion in the horizontal direction of the front opening portion of the cold storage chamber and wind direction plates guiding cold air to the right and left are provided in the door duct in each invention described above.

### Advantageous Effect of the Invention

According to the present invention, in the cold storage for in-vehicle use obtained by configuring the cold storage chamber in the heat insulating body and openably/closably closing the front opening portion of the cold storage chamber with the heat insulating door, the cold accumulating chamber configured in the bottom portion in the body, the cold accumulating agent provided in the cold accumulating chamber, the metal partition plate attached to the inside of the back surface and the top surface of the body with an interval, the body duct configured between the partition plate and the body and extending to the ceiling portion of the cold storage chamber while communicating with the back portion of the cold accumulating chamber, the outlet formed in the body duct and opening at the ceiling portion of the cold storage chamber, the fan blowing cold air which has heat-exchanged with the cold accumulating agent from the outlet through the body duct, the metal door duct member attached to the inside of the door with an interval, and the door duct configured between the door duct member and the door are provided and the upper portion of the door duct communicates with the outlet and the lower portion of the door duct communicates with the front portion of the cold accumulating chamber in the state where the door closes the front opening portion of the cold storage chamber. Therefore, the cold air which has heat-exchanged with the cold accumulating agent in the cold accumulating chamber repeats the circulation in which the cold air is blown into the door duct from the outlet through the body duct and returns to the cold accumulating chamber through the door duct by the fan.

Thus, articles stored in the cold storage chamber are indirectly cooled from the circumference through the partition plate and the door duct member which are formed of metal by the cold air circulated through the inside of the body duct and the door duct. Thus, the drying of the articles is significantly suppressed. Therefore, even in the case of articles vulnerable to dryness, the deterioration in the quality can be prevented or reduced.

In this case, the inside of the cold storage chamber is indirectly cooled from the back portion, the ceiling portion, and the front portion. The door duct member located in the front portion is removed from the front opening portion of the cold storage chamber with the opening of the door. Therefore, the door duct member for configuring the door duct does not hinder the taking-out of articles.

Moreover, when the upper portion of the door duct member is caused to abut on the partition plate around the outlet through the seal material in the state where the door closes the front opening portion of the cold storage chamber as with the invention of Claim 2, the cold air does not directly leak into the cold storage chamber from the outlet and the entire cold air blown from the outlet can be smoothly made to flow into the door duct in the state where the door closes the front opening portion of the cold storage chamber, so that indirect cooling from the door duct member can be achieved without problems.

Meanwhile, in the case of only the indirect cooling from the partition plate and the door duct member, there is a risk that the cooling effect is insufficient when a large number of articles are stored. However, the plurality of small holes are formed in the door duct member as with the invention of Claim 3, the cold air flowing into the door duct can be partially made to directly leak into the cold storage chamber. Thus, the cooling effect can be compensated, so that the quality deterioration due to a temperature rise can also be prevented or reduced while suppressing the drying of the articles in the cold storage chamber to the minimum.

In this case, most of the cold air which is made to leak into the cold storage chamber will stay in a lower portion. Therefore, when a larger number of small holes are formed in the upper portion than in the lower portion as with the invention of Claim 4, for example, the cooling effect in the cold storage chamber by the cold air leaking from the small holes can be uniformized in the vertical direction.

Thus, also when the small holes are formed in the door duct member, the cold air leaking into the cold storage chamber from the small holes can also be smoothly returned into the cold accumulating chamber by communicating the inside of the cold storage chamber with the front portion of the cold accumulating chamber as with the invention of Claim 5.

The bottom plate for partitioning and forming the cold accumulating chamber below is provided in the cold storage chamber. When the door duct member is located on the front side with respect to the front end of the bottom plate in the state where the door closes the front opening portion of the cold storage chamber as with the invention of Claim 6, the door duct member is located on the front side with respect to the front end of articles to be placed on the bottom plate. Thus, the trouble that the stored articles and the door duct member interfere with each other, so that the door does not close, for example, is eliminated and the door duct member fills the clearance inside the door which has been conventionally required to be secured as a cold air suction space. Therefore, the trouble that the articles in the cold storage chamber move forward and backward by a shock generated during conveyance can also be suppressed, so that the quality deterioration by crushing or the like can be prevented or reduced.

In the case where the outlet is located in the central portion in the horizontal direction of the front opening portion of the cold storage chamber, the wind direction plates guiding cold air to the right and left are provided in the door duct as with the invention of Claim 7. Thus, the amount of the cold air flowing down in the door duct under is uniformized in the horizontal direction, so that the cooling effect from the door duct member and the leakage amount when the small holes are formed as with claim 3 can be uniformized in the horizontal direction of the cold storage chamber.

### BRIEF DESCRIPTION OF THE DRAWINGS

FIG. 1 is a front view of a cold storage for in-vehicle use to which the present invention is applied

FIG. 2 is a vertical cross-sectional side view of the cold storage for in-vehicle use of FIG. 1.

FIG. 3 is a figure in which a door of the cold storage for in-vehicle use of FIG. 1 is viewed from the inside (blown from 1).

FIG. 4 is a figure in which a door of another Example of the cold storage for in-vehicle use of FIG. 1 is viewed from the inside (Example 2).

FIG. 5 is a figure in which a door of still another Example of the cold storage for in-vehicle use of FIG. 1 is viewed from the inside (Example 3).

### MODE FOR CARRYING OUT THE INVENTION

Hereinafter, an embodiment of the present invention is described in detail with reference to the drawings.

### EXAMPLE 1

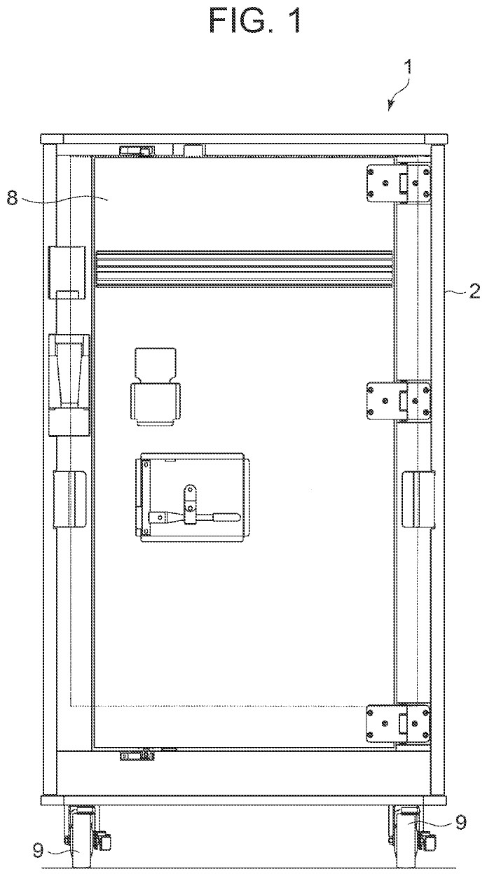

FIG. 1 to FIG. 3 illustrate one embodiment of a cold storage for in-vehicle use to which the present invention is applied. As illustrated in FIG. 1, a cold storage for in-vehicle use 1 of an Example is provided with a body 2 containing a heat insulating casing having an opened front surface, a cold storage chamber 3 configured in the body 2 and having an opened front surface (front opening portion 3A), a cooling device 4 for cooling the inside of the cold storage chamber 3, a cold accumulating agent 6, and a fan 7 for circulating cold air.

To the body 2, a heat insulating door 8, one side of which is pivotally supported on the body 2, is attached. By the door 8, the front opening portion 3A of the cold storage chamber 3 is openably/closably closed. Casters (wheels) 9 for movement are attached to the undersurface of the body 2. The casters 9 are used for bringing the cold storage for in-vehicle use 1 into/out of a transportation vehicle or the movement in a distribution center. On the upper surface of the body 2, a machine room 11 is configured. In the machine room 11, a compressor 12, a condenser 13, a condenser fan 14, a battery 16, and the like of the cooling device 4 are placed.

Meanwhile, a heat insulating bottom plate 17 is detachably attached to the body 2 with an interval from the bottom surface in a bottom portion in the cold storage chamber 3. Below the bottom plate 17, a cold accumulating chamber 18 is partitioned and formed. In the cold accumulating chamber 18, a cooler 19 configuring a well-known refrigerant circuit of the cooling device 4 with the compressor 12 and the condenser 13 is disposed. The cold accumulating agent 6 described above is provided in the cold accumulating chamber 18 in a heat exchange relationship with the cooler 19.

The cooling device 4 is operated in an environment where commercial power is supplied, such as a delivery center. By cooling the cold accumulating agent 6 by the cooler 19, the cold accumulating agent 6 is frozen to store cold. In this case, the battery 16 is charged and the fan 7 is also operated so that the cold air cooled with the cooler 19 is circulated by the fan 7 as in the case of conveying as described later.

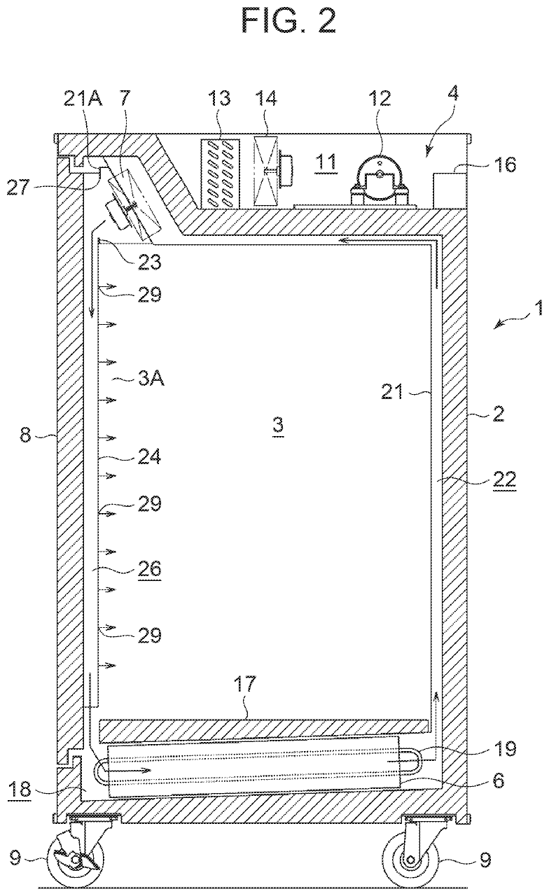

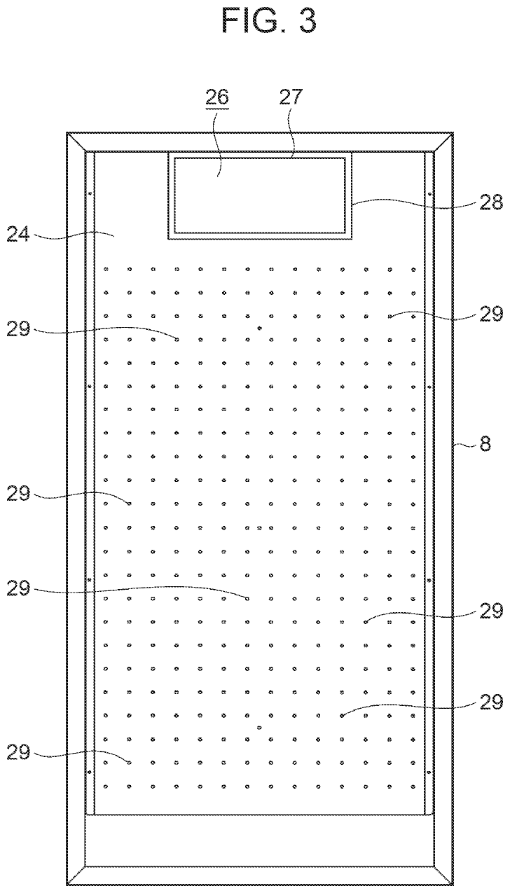

Next, the duct structure in the cold storage chamber 3 is described with reference to FIG. 2 and FIG. 3. To the inside (front side) of the back surface and the inside of the top surface (lower side) of the body 2, a metal (materials having high thermal conductivity, such as stainless steel) partition plate 21 is attached with an interval. Between the partition plate 21 and the body 2, a body duct 22 extending from a back portion to a ceiling portion of the cold storage chamber 3 is configured. In this case, the lower end of the partition plate 21 located in the back portion of the cold storage chamber 3 is located on the rear side of the rear end of the bottom plate 17 and the lower end of the body duct 22 of the back portion communicates with a back portion of the cold accumulating chamber 18.

The front end (indicated by 21A) of the partition plate 21 located in the ceiling portion of the cold storage chamber 3 is located slightly on the inner side of the front opening portion 3A. In the front end 21A, an outlet 23 is formed. In this case, the outlet 23 is located in a central portion (central portion in the horizontal direction of the front end 21A of the partition plate 21) in the horizontal direction of the front opening portion 3A of the cold storage chamber 3 in this Example. The fan 7 is disposed in the body duct 22 corresponding to the inside of the outlet 23 and is configured to be operated to blow cold air from the outlet 23 forward and downward (direction toward the front opening portion 3A and downward direction).

Meanwhile, a metal (similarly stainless steel or the like) door duct member 24 is attached to the inside of the door 8 with an interval extending over the upper side and the lower side. Between the door duct member 24 and the door 8, a door duct 26 extending over the upper side and the lower side is configured. Right, left, and upper portions of the door duct 26 are closed. In a central portion of an upper portion of the door duct member 24, an inflow port 27 for causing cold air to flow into the door duct 26 is formed to communicate with the door duct 24 as illustrated in FIG. 3. Furthermore, it is configured so that a seal material 28 is attached to the circumference of the inflow port 27, the upper portion of the door duct member 24 abuts on the front end 21A of the partition plate 21 through the seal material 28 in a state where the door 8 closes the front opening portion 3A, and, in the state, the inflow port 27 corresponds to the outlet 23 and the upper portion of the door duct 26 communicates with the outlet 23 (body duct 22).

Furthermore, it is configured so that the door duct member 24 is located above and on the front side with respect to the bottom plate 17 in the state where the door 8 closes the front opening portion 3A. It is configured so that a lower portion of the door duct 26 is opened and the lower portion of the door duct 26 communicates with the front portion of the cold accumulating chamber 17 in the state where the door 8 closes the front opening portion 3A of the cold storage chamber 3. In the door duct member 24, a plurality of small holes 29 is formed over the upper and lower portions as illustrated in FIG. 3.

Under the configuration described above, the cold air circulation by the fan 7 is described below. When the fan 7 is driven by the battery 16, the cold air in the cold accumulating chamber 18 which has been cooled by heat-exchanging with the cold accumulating agent 6 (the cooler 19 when commercial power is supplied as described above or the cooler 19 and the cold accumulating agent 6) is sucked from the back portion of the cold accumulating chamber 18 as indicated by the arrows in FIG. 2, goes up in the body duct 22 in the back portion, reaches the fan 7 through the body duct 22 of the ceiling portion, and then blown into the door duct 26 from the outlet 23.

Then, the cold air blown into the door duct 26 flows down in the door duct 26, flows out of the lower end, flows into the front portion of the cold accumulating chamber 18 through the clearance between the door 8 and the front end of the bottom plate 17, and then heat-exchanges with the cold accumulating agent 6 again. The cold air blown into the door duct 26 partially leaks (blown out) into the cold storage chamber 3 from the small holes 29 as indicated by the arrows illustrated in FIG. 2. Then, the cold air leaking into the cold storage chamber 3 also repeats the circulation of flowing into the front portion of the cold accumulating chamber 18 through the clearance between the door 8 and the front end of the bottom plate 17, and then heat-exchanging with the cold accumulating agent 6 again.

As described above, in the cold storage for in-vehicle use 1 of the present invention, the cold air which has heat-exchanged with the cold accumulating agent 6 in the cold accumulating chamber 18 repeats the circulation of being blown into the door duct 26 from the outlet 23 through the body duct 22 by the fan 7, and then returning to the cold accumulating chamber 18 through the door duct 26.

Thus, articles stored in the cold storage chamber 3 are indirectly cooled from the circumference (back portion, ceiling portion, and front portion) through the partition plate 21 and the door duct member 24 which are formed of metal by the cold air circulated through the inside of the body duct 22 and the door duct 26. Thus, the drying of the articles is significantly suppressed. Therefore, also when articles vulnerable to dryness, such as fresh vegetables, are stored and conveyed, the deterioration in the quality can be effectively prevented or reduced.

In this case, the inside of the cold storage chamber 3 is indirectly cooled from the back portion, the ceiling portion, and the front portion. The door duct member 24 located in the front portion is removed from the front opening portion 3A of the cold storage chamber 3 with the opening of the door 8. Therefore, the door duct member 24 for configuring the door duct 26 does not hinder the taking-out of the articles from the front opening portion 3A.

It is also configured in this Example so that the upper portion of the door duct member 24 abuts on the partition plate 21 (front end 21A) around the outlet 23 through the seal material 28 in the state where the door 8 closes the front opening portion 3A of the cold storage chamber 3. Therefore, the cold air is prevented from directly leaking into the cold storage chamber 3 from the outlet 23 in the state where the door 8 closes the front opening portion 3A of the cold storage chamber 3, so that the entire cold air blown from the outlet 23 smoothly flows into the door duct 26. Thus, indirect cooling from the door duct member 24 can be achieved without problems.

Herein, in the case of only the indirect cooling from the partition plate 21 and the door duct member 24, there is a risk that the cooling effect is insufficient when a large number of articles are stored in the cold storage chamber 3. Then, the plurality of small holes 29 is formed in the door duct member 24 in this Example, and therefore the cold air flowing into the door duct 26 partially directly leaks into the cold storage chamber 3. Thus, the cooling effect can be compensated, so that the quality deterioration due to a temperature rise can also be prevented or reduced while suppressing the drying of the articles in the cold storage chamber 3 to the minimum.

Also when the small holes 29 are formed in the door duct member 24 as described above, the inside of the cold storage chamber 3 is communicated with the front portion of the cold accumulating chamber 18 in this Example. Therefore, the cold air leaking into the cold storage chamber 3 from the small holes 29 can also be smoothly returned to the cold accumulating chamber 18.

Moreover, it is also configured in this Example so that the door duct member 24 is located on the front side with respect to the front end of the bottom plate 17 in the state where the door 8 closes the front opening portion 3A of the cold storage chamber 3, and therefore the door duct member 24 is located on the front side with respect to the front end of articles to be placed on the bottom plate 17. Thus, the trouble that the stored articles and the door duct member 24 interfere with each other when closing the door 8, so that the door 8 does not close, for example, is eliminated.

Moreover, the clearance inside the door 8 which has been conventionally required to be secured as a cold air suction space is filled with the door duct member 24. Therefore, even when articles in the cold storage chamber 3 tend to move forward and backward by a shock generated during conveyance, the movement is suppressed by the door duct member 24. Thus, the quality deterioration by crushing or the like of the articles can be prevented or reduced.

### EXAMPLE 2

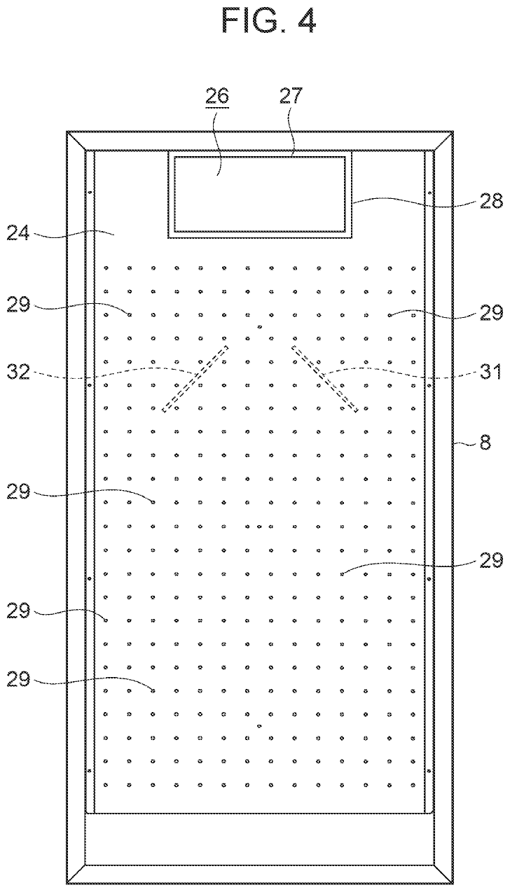

Next, FIG. 4 illustrates a figure in which a door 8 of another Example of the present invention is viewed from the inner surface. In this Example, wind direction plates 31 and 32 are attached to an upper portion in the door duct 26. The wind direction plates 31 and 32 are disposed side by side on the right and left with an interval and are inclined so that the right end of the wind direction plate 31 on the right side when viewed from the inner surface of the door 8 is lowered and the left end of the wind direction plate 32 on the left side is lowered.

Herein, the outlet 23 is formed in a central portion in the horizontal direction of the front opening portion 3A of the cold storage chamber 3 in the cold storage for in-vehicle use 1 of this Example. Therefore, cold air blown from the outlet 23 flows into a central portion of the upper portion of the door duct 26. Hence, the cold air will increase in the door duct 26 located in the central portion in the horizontal direction and decrease in the right and left ends in the door duct 26. Thus, the cooling capacity from the door duct member 24 or the leakage amount from the small holes 29 increases in the central portion and decreases in the right and left ends.

Thus, when the wind direction plates 31 and 32 are attached in the door duct 26 as with this Example, most of the cold air flowing from the inflow port 27 in the central portion flows down while being guided to the right and left sides by the wind direction plates 31 and 32. Thus, the amount of the cold air flowing down in the door duct 26 is uniformized in the horizontal direction, so that the cooling effect from the door duct member 24 or the leakage amount of the cold air from the small holes 29 is uniformized in the horizontal direction of the cold storage chamber 3.

### EXAMPLE 3

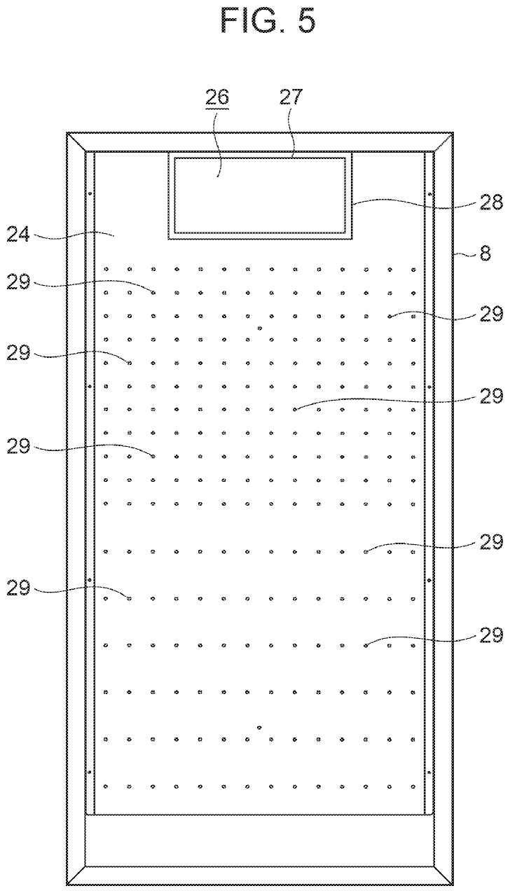

Next, FIG. 5 illustrates a figure in which a door 8 of still another Example of the present invention is viewed from the inner surface. In this Example, a larger number of small holes 29 are formed in an upper portion than in a lower portion of the door duct member 24 (in this Example, the number of the small holes 29 formed in the upper portion is twice the number of the small holes 29 formed in the lower portion). Herein, most of cold air leaking into the cold storage chamber 3 will stay in the lower portion. Therefore, when the small holes 29 are substantially equally formed over the upper and lower portions as illustrated in FIG. 3 described above, the lower portion in the cold storage chamber 3 will be more strongly cooled than the upper portion.

Thus, by forming a larger number of small holes 29 in the upper portion than in the lower portion of the door duct member 24 as with this Example, the cooling effect in the cold storage chamber 3 by the cold air leaking from the small holes 29 can be uniformized in the vertical direction.

In each Example described above, the present invention is applied to the cold storage for in-vehicle use 1 provided with the cooling device 4 and freezing the cold accumulating agent 6 by the cooler 19. However, the present invention is effective also in a cold storage for in-vehicle use in which the cold accumulating agent 6 is frozen in the outside beforehand and mounted, i.e., a cold storage for in-vehicle use not having a cooling device.

### DESCRIPTION OF REFERENCE NUMERALS

1 cold storage for in-vehicle Use

2 body

3 cold storage chamber

6 cold accumulating agent

7 fan

8 door

9 caster

17 bottom plate

18 cold accumulating chamber

21 partition plate

22 body duct

23 outlet

24 door duct member

26 door duct

28 seal material

31, 32 wind direction plate

1. A cold storage for in-vehicle use, which is obtained by configuring a cold storage chamber in a heat insulating body and openably/closably closing a front opening portion of the cold storage chamber with a heat insulating door, the cold storage for in-vehicle use comprising:
a cold accumulating chamber configured in a bottom portion in the body;
a cold accumulating agent provided in the cold accumulating chamber;
a metal partition plate attached to inside of a back surface and a top surface of the body with an interval;
a body duct configured between the partition plate and the body and extending to a ceiling portion of the cold storage chamber while communicating with a back portion of the cold accumulating chamber;
an outlet formed in the body duct and opening at the ceiling portion of the cold storage chamber;
a fan blowing cold air which has heat-exchanged with the cold accumulating agent from the outlet through the body duct;
a metal door duct member attached to inside of the door with an interval; and
a door duct configured between the door duct member and the door, wherein
an upper portion of the door duct communicates with the outlet and a lower portion of the door duct communicates with a front portion of the cold accumulating chamber in a state where the door closes the front opening portion of the cold storage chamber.

2. The cold storage for in-vehicle use according to claim 1, wherein
the upper portion of the door duct member abuts on the partition plate around the outlet with a seal material in between in the state where the door closes the front opening portion of the cold storage chamber.

3. The cold storage for in-vehicle use according to claim 1, wherein
a plurality of small holes is formed in the door duct member.

4. The cold storage for in-vehicle use according to claim 3, wherein
a larger number of small holes are formed in an upper portion than in a lower portion of the door duct member.

5. The cold storage for in-vehicle use according to claim 3, wherein
inside of the cold storage chamber communicates with a front portion of the cold accumulating chamber.

6. The cold storage for in-vehicle use according to claim 1, comprising:
a bottom plate provided in the cold storage chamber and partitioning and forming the cold accumulating chamber below, wherein
the door duct member is located on a front side with respect to a front end of the bottom plate in the state where the door closes the front opening portion of the cold storage chamber.

7. The cold storage for in-vehicle use according to claim 1, wherein
the outlet is located in a central portion in a horizontal direction of the front opening portion of the cold storage chamber and wind direction plates guiding cold air to right and left are provided in the door duct.
